(19) United States
(12) Patent Application Publication
(10) Pub. No.: US 2004/0161249 A1
(43) Pub. Date: Aug. 19, 2004

(54) Optical transmitter

(75) Inventors: Atsushi Suda, Yokohama (JP); Akihiko Hayashi, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/776,265

(22) Filed: Feb. 12, 2004

(30) Foreign Application Priority Data
Feb. 13, 2003 (JP) 2003-035725

(51) Int. Cl. H04B 10/04

(52) U.S. Cl. 398/198

(57) ABSTRACT

In addition to a pilot signal for the conventional operating point control, a second pilot signal with a different frequency is superimposed on an optical signal. Then, the modulation component of an optical signal corresponding to the second pilot signal is detected from the output of an external modulator, the phase of the modulation component of the optical signal is compared with the phase of the second pilot signal, and as a result, an amplitude is obtained. The amplitude of a signal indicating a phase difference obtained when the amplitude of the driving waveform of the external modulator is different from the Vπ of the external modulator is detected, using the amplitude of the signal indicating the phase difference obtained when the amplitude of the driving waveform is the same as Vπ, as a reference, and the amplitude of the driving waveform.

### BACKGROUND OF THE INVENTION

1. Field of the Invention

The present invention relates to an optical transmitter provided with an optical modulator.

2. Description of the Related Art

Conventionally, in external modulation type optical transmitters used in optical communication systems, in order to achieve the stable operation of optical communication systems, it has been required to cope with the operating point drift of an optical modulator, and a variety of operating point stabilizing method have been used for optical modulators. However, since in recent optical communication systems, WDM or a flexible bit rate is often adopted, it is necessary to switch a transmission wavelength or a transmission rate from the viewpoint of a system. Therefore, if a transmission wavelength or a transmission rate changes, the change of a static characteristic (change of the Vπ characteristic of an external modulator) cannot be sufficiently coped with only by the compensation control over the change of an operating point (temperature drift, etc.) of an optical modulator (Japanese Patent No. 2,642,499). Therefore, the development of an optical transmitter whose waveform does not degrade even if the static characteristic of an external modulator changes, is required.

FIG. 1 is a graph showing the change of a Vπ characteristic.

In a Mach-Zehnder external modulator using lithium niobate, there is a sine wave-like cyclical relationship between bias voltage and optical output. In optical modulation, the slope of one of the mountains of this cyclical relationship is used. If the wavelength of light inputted to this external modulator changes or its transmission rate changes, a Vπ characteristic changes as shown in FIG. 1. Therefore, an optical modulator that was operating between the peak of a mountain and the bottom of a valley of the characteristic curve in order to maximize an extinction ratio in optical modulation, operates in a position away from the position described above if the Vπ characteristic changes. Thus, the waveform of an optical signal generated by the external modulator degrades. Conventionally, a technology on the drift of the operating point whose position slides without the change of the cyclical Vπ characteristic is disclosed.

FIG. 2 shows the prior art.

The technology shown in FIG. 2 is disclosed by patent document 1.

Reference numerals 1, 2, 3, 4, 5, 6, 7, 8, 9 and 10 represent a light source using a semiconductor laser, etc., an external modulator, a signal electrode, a photo-detector, a pilot signal detecting circuit, a phase comparing circuit, an operating point controlling circuit, a pilot signal generator, a modulator driving circuit and a bias circuit, respectively.

CW (continuous) light is inputted to the external modulator 2 from the light source 1 and is modulated by a PCM-modulated electric signal generated by the modulator driving circuit 9 in the signal electrode. Then, an optical signal is outputted. The optical signal is split by the external modulator 2 and is inputted to the photo-detector 4. The photo-detector 4 is comprised of photo-diodes. The photo-detector 4 converts the intensity of the optical signal into monitor current and outputs it to the pilot signal detecting circuit 5.

The pilot signal generator 8 has a low frequency such that it does not affect the PCM-modulated electric signal, and the frequency is inputted to the modulator driving circuit 9 of the external modulator. Then, the pilot signal generator 8 superimposes a pilot signal on the optical signal by modulating the bias voltage of the signal electrode by the low frequency. In the pilot signal detecting circuit 5, the low-frequency pilot signal superimposed on the optical signal, which is obtained by modulating the bias voltage, is detected. The phase of the detected pilot signal is compared with that of the signal generated by a pilot signal generator 8 by the phase comparison circuit 6. The operating point controlling circuit 7 optimally operates the bias voltage of the signal electrode through the bias circuit 10, based on the result. Thus, the external modulator stably operates without being affected by the drift of the bias voltage. This bias voltage characteristic and the respective operations of a PCM signal, a pilot signal and optical output, which is the operations of the prior art, are shown in FIG. 3.

FIG. 3 is a diagram showing an operation of the prior art.

An LN bias voltage is applied to the driving electrode of a Mach-Zehnder external modulator (LN modulator) using lithium niobate. An LN driving signal is an electric signal, and has a bias voltage to be applied to the driving electrode of the LN modulator to convert the LN driving signal into an optical signal. The pilot signal is changing the signal amplitude of this LN driving voltage. If the operating point is correctly set, the optical signal becomes that is amplitude-modulated by a frequency twice as much as that of a pilot signal.

Patent document 2 discloses a technology for detecting the power level of an optical signal outputted from the external modulator and for maintaining the output power of the optical signal constant.

patent document 1: Japanese Patent No. 2,642,499

Patent document 2: Japanese Patent Laid-open No. 2000-196,185.

If the wavelength of an optical signal inputted to an external modulator does not change, a stable operation is obtained by controlling the drift of an operating point, using the prior art. However, when the wavelength of CW light or the bit rate of a PCM signal is changed by the light source 1, Vπ characteristic changes, and the amplitude and extinction ratio of an optical output signal degrades. In this case, the bias characteristic, that is, Vπ characteristic also degrades.

Specifically, as shown in FIG. 4, which shows conventional problems, if the wavelength of CW light or the bit rate of a PCM signal is changed by the light source 1, in the characteristic curve of the bias voltage vs. optical output of an external modulator (LN modulator), Vπ, being the difference between a bias voltage needed to obtain the maximum optical output and that needed to obtain the minimum optical output, sometimes increases and sometimes decreases. However, if the amplitude of the PCM signal, being the driving signal of the LN modulator, is maintained constant, the amplitude of an outputted optical signal becomes small or its extinction ratio becomes large when Vπ becomes large or small, which is a problem.

Even in an optical transmitter in which the bias characteristic of an external modulator is compensated for the drift of temperature, power supply, etc., it is important to stably operate without the degradation of both the amplitude and extinction ratio of an optical output signal, even when the bias characteristic of the external modulator, that is, Vπ characteristic changes.

### SUMMARY OF THE INVENTION

Therefore, it is an object of the present invention to provide an optical modulator for optimally conducting optical modulation even if the bit rate of a driving signal or the wavelength of an optical signal that is inputted to an external modulator, changes, and as a result, the bias characteristic changes.

The optical modulator of the present invention which has a function to compensate for the change of the static characteristic of an external modulator comprises a superimposition unit superimposing a signal with a low frequency on an optical signal outputted by the external modulator, a extraction unit extracting an optical signal component, corresponding to the superimposed signal, a comparison unit comparing the extracted signal with the signal with the low frequency, and a changing unit changing the amplitude of a driving signal to be supplied to the external modulator.

According to the present invention, even if the static characteristic of an external modulator is changed by the change of the wavelength of light inputted by the external modulator or the change of the bit rate of a signal obtained by modulation, the amplitude of a driving signal can be appropriately set. Therefore, the amplitude and extinction ratio of an optical output signal, being the output of the external modulator can be optimally maintained.

### BRIEF DESCRIPTION OF THE DRAWINGS

FIG. 1 is a graph showing the change of a Vπ characteristic;

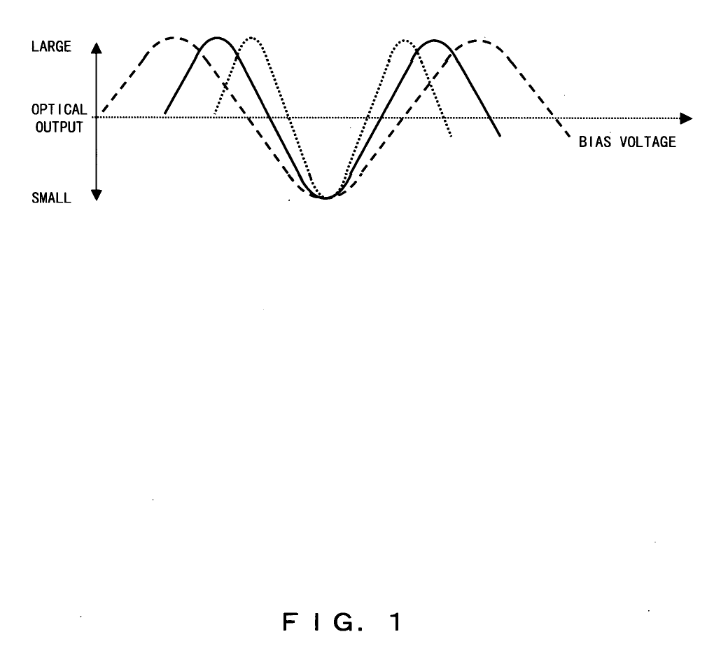

FIG. 2 shows a prior art;

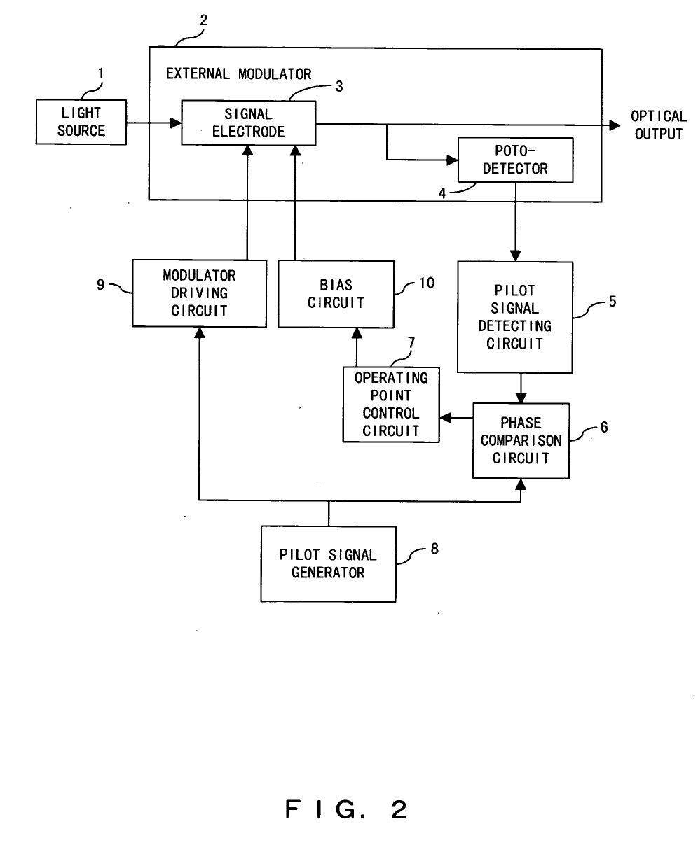

FIG. 3 shows the operation of the prior art;

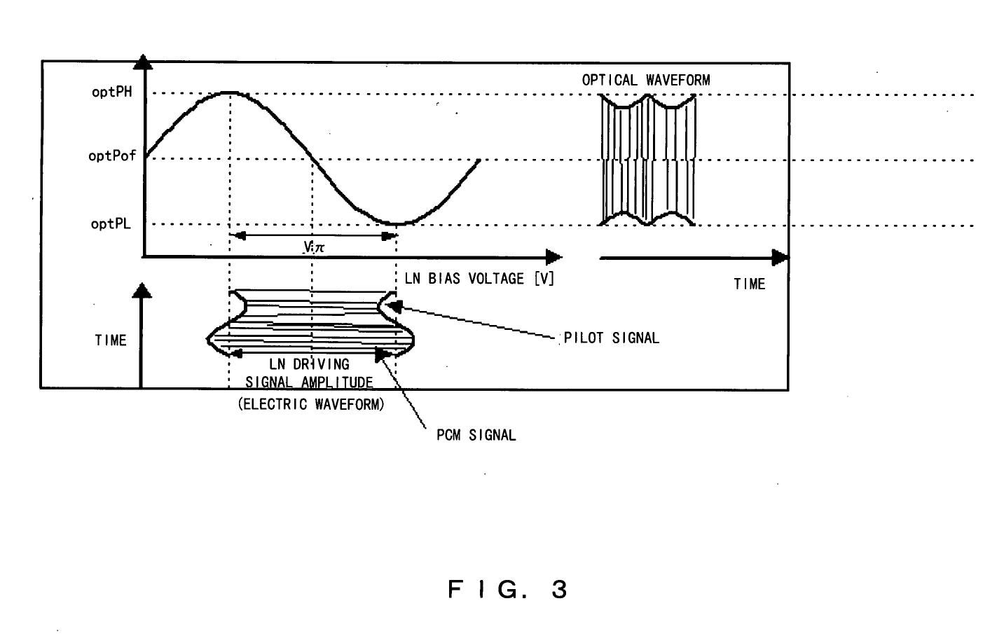

FIG. 4 shows the conventional problem;

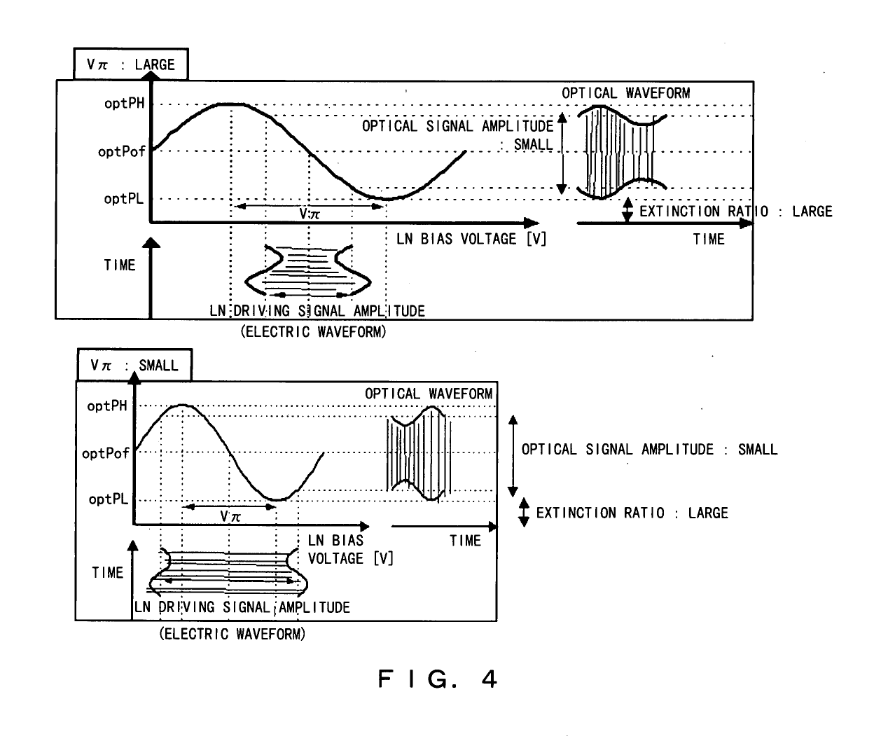

FIG. 5 shows the first principle of the present invention (No. 1);

FIG. 6 shows the first principle of the present invention (No. 2);

FIG. 7 shows the first principle of the present invention (No. 3);

FIG. 8 shows the first principle of the present invention (No. 4);

FIG. 9 shows the second principle of the present invention (No. 1);

FIG. 10 shows the second principle of the present invention (No. 2);

FIG. 11 shows the second principle of the present invention (No. 3);

FIG. 12 shows the second principle of the present invention (No. 4);

FIG. 13 shows the first configuration of the optical modulator according to the first principle;

FIG. 14 shows the second configuration of the optical modulator according to the first principle;

FIG. 15 shows the configuration of the optical modulator according to the second principle;

FIG. 16 shows each signal waveform in an operation according to the second principle (No. 1);

FIG. 17 shows each signal waveform in an operation according to the second principle (No. 2); and

FIG. 18 shows each signal waveform in an operation according to the second principle (No. 3).

### DESCRIPTION OF THE PREFERRED EMBODIMENTS

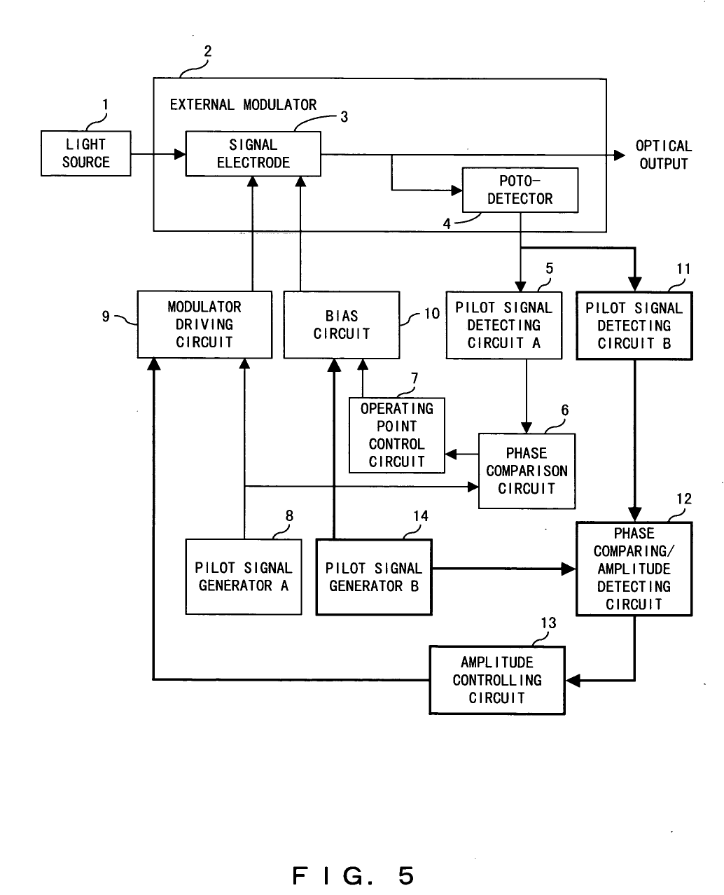

FIGS. 5 through 8 show the first principle of the present invention.

Each function is as follows.

(1) The phase and amplitude of a pilot signal are detected and are fed back to a modulation driving circuit to change the driving amplitude of a PCM signal.

FIG. 5 shows the basic configuration of the optical modulator according to the first principle.

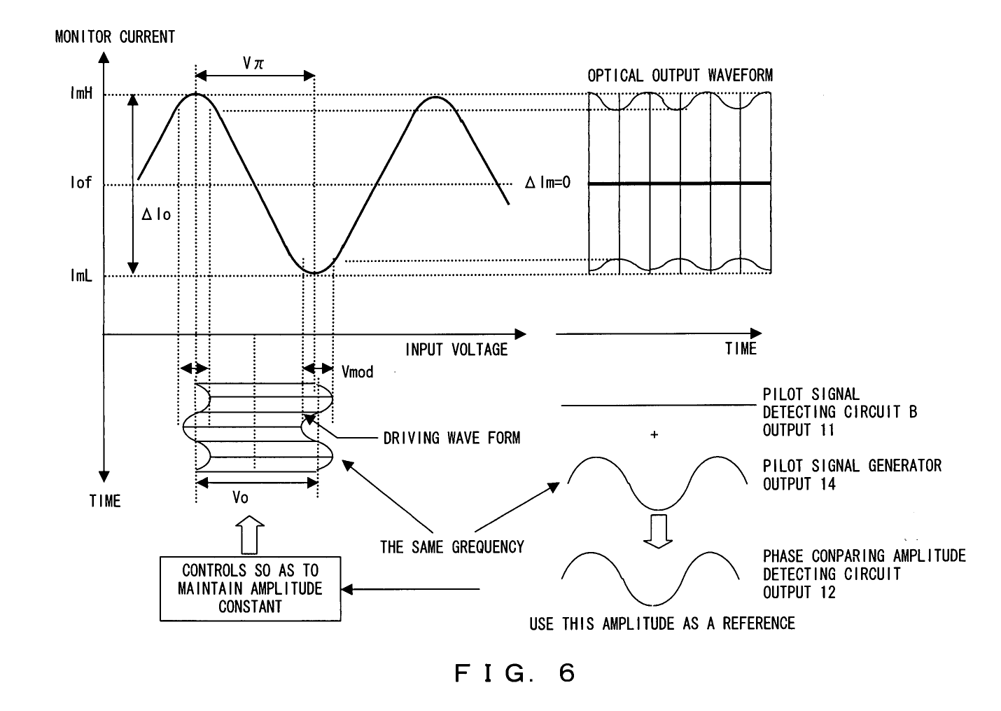

In FIG. 5, a function to superimpose a pilot signal of a different frequency on an optical signal, using the bias circuit 10, to detect the optical signal and to control it, is provided in addition to the conventional drift compensation circuit (indicated by thin lines). Therefore, the description for the conventional drift compensation circuit is omitted. A photo-detector 4 detects the pilot signal superimposed by the bias circuit 10. Then, a phase comparing/amplitude detecting circuit 12 compares the output phase of a pilot signal generator B14 with that of a pilot signal detecting circuit B 11 and detects an amplitude. Based on the output signal of this phase comparing/amplitude detecting circuit 12, an amplitude controlling circuit 13 changes the driving amplitude of the modulator so that the amplitude and extinction ratio of the optical output signal can be maintained constant even if the Vπ characteristic changes. The functions identified by reference numerals 1 through 10 are the same as conventional ones. Their operations are shown in FIGS. 6 through 8.

a) In the case that driving waveform amplitude is the same as Vπ (FIG. 6)

Firstly, if the amplitude of the electric input (driving waveform) of an external modulator is the same as Vπ, a superimposed pilot signal touches or crosses the extremum point in the static characteristic curve of the external modulator. Therefore, the superimposed pilot signal takes the optical output waveform shown in FIG. 6.

If the photo-detector 4 extracts the same frequency as the pilot signal from the optical output and detects the pilot signal superimposed by the bias circuit 10, the output (output 11 in FIG. 6) becomes direct current. Specifically, in this case, the amplitude change of the optical output waveform becomes twice as much as the frequency of the pilot signal. This is because the optical output first increases and then returns its original value while the driving waveform moves from one side of extremum point to the other side of that since the driving waveform changes before and after the extremum point of the static characteristic curve of the external modulator. The phase comparing/amplitude detecting circuit 12 compares the output phase of the pilot signal generator B 14 with that of the pilot signal detecting circuit B 11 using, for example, a simple addition circuit, and detects its amplitude by converting the phase difference into an amplitude (In this case, there is no phase difference in the output 11. However, if the amplitude of the driving waveform is not the same as Vπ, there is a phase difference).

In this case, an amplitude controlling circuit 13 determines that the amplitude of the drive waveform is the same as Vπ, and controls the output signal of this phase comparing/amplitude detecting circuit 12 so that the driving waveform of the modulator is maintained as it is, using this amplitude as a determination reference of the relationship between Vπ and the amplitude of the driving waveform.

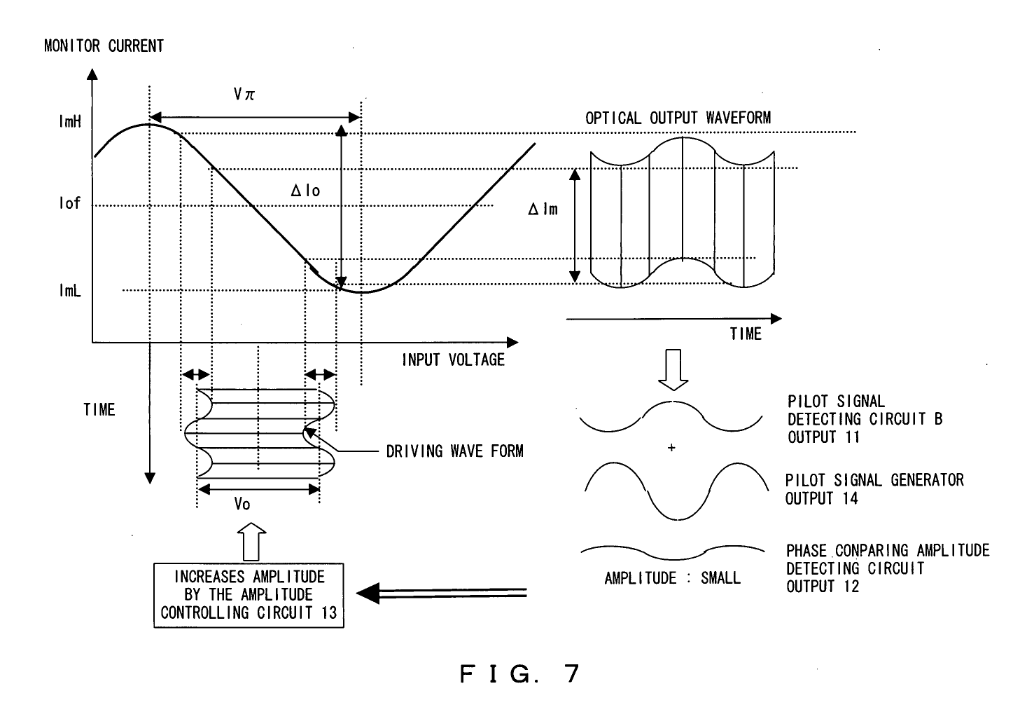

b) In the case that the amplitude of the electric input (driving waveform) of the external modulator is smaller than Vπ (FIG. 7)

In this case, since the superimposed pilot signal neither touches nor crosses the extremum point of the static characteristic curve of the external modulator, the superimposed pilot signal takes the optical output waveform shown in FIG. 7.

If the photo-detector 4 extracts the same frequency as the pilot signal from the optical output and detects the pilot signal superimposed by the bias circuit, the phase of the output (output 11 in FIG. 7) becomes the reverse of that of the imposed pilot signal. The phase comparing/amplitude detecting circuit 12 compares the output phase of the pilot signal generator B 14 with that of the pilot signal detecting circuit B 11 using, for example, a simple addition circuit and detects an amplitude by converting the phase difference into amplitude.

Since the phase of the output 14 is the reverse of that of the output 11, the amplitude of the output signal of this phase comparing/amplitude detecting circuit 12 becomes smaller than that of an output 14. In this case, the amplitude of the driving waveform is determined to be smaller than Vπ, and the amplitude controlling circuit 13 controls amplitude so that the driving amplitude of the modulator becomes larger than Vπ.

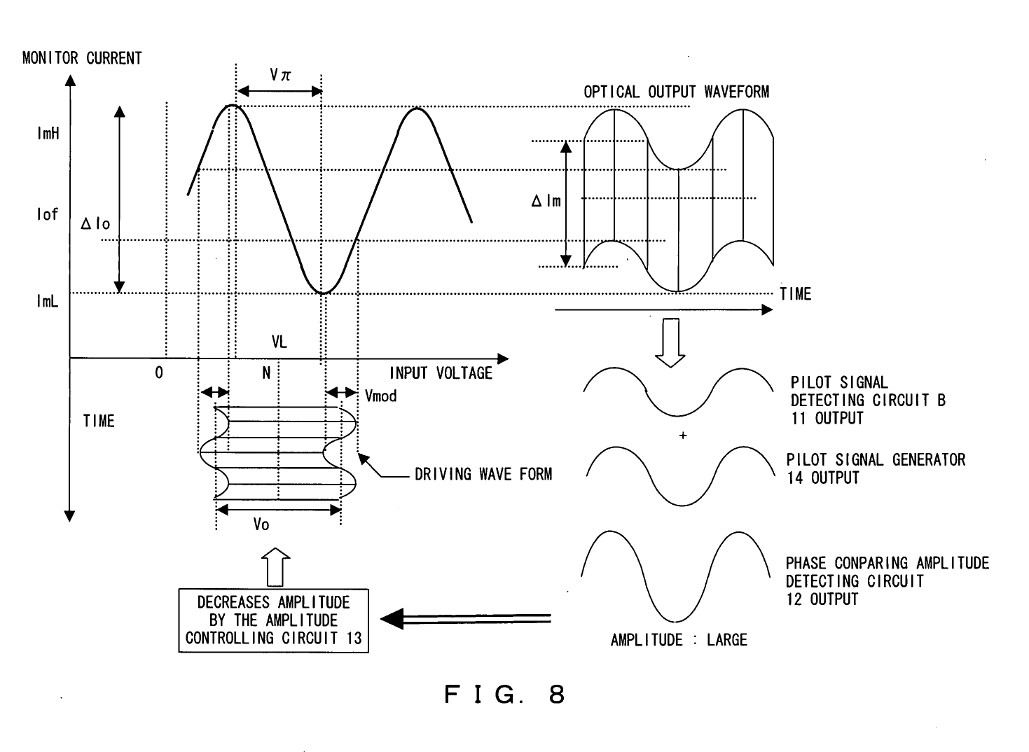

c) In the case that the amplitude of the driving waveform is larger than Vπ (FIG. 8)

If the amplitude of the electric input (driving waveform) of the external modulator is larger than Vπ, the superimposed pilot signal is located outside the extremum point of the static characteristic curve of the external modulator. Therefore, the superimposed pilot signal takes the optical output waveform shown in FIG. 8.

If the photo-detector 4 extracts the same frequency as the pilot signal from the optical output and detects the pilot signal superimposed by the bias circuit, the phase of the output (output 11 in FIG. 8) becomes almost the same as that of the superimposed pilot signal. The phase comparing/amplitude detecting circuit 12 compares the output phase of the pilot signal generator B14 with that of the pilot signal detecting circuit B11 using, for example, a simple addition circuit and detects an amplitude by converting the phase difference into amplitude.

Since the phase of the output 14 is the same as the output 11, the amplitude of the output signal of this phase comparing/amplitude detecting circuit 12 becomes larger than that of that output 14. In this case, the amplitude of the driving waveform is determined to be larger than Vπ, and the amplitude controlling circuit 13 controls amplitude so that the driving amplitude of the modulator becomes smaller than Vπ.

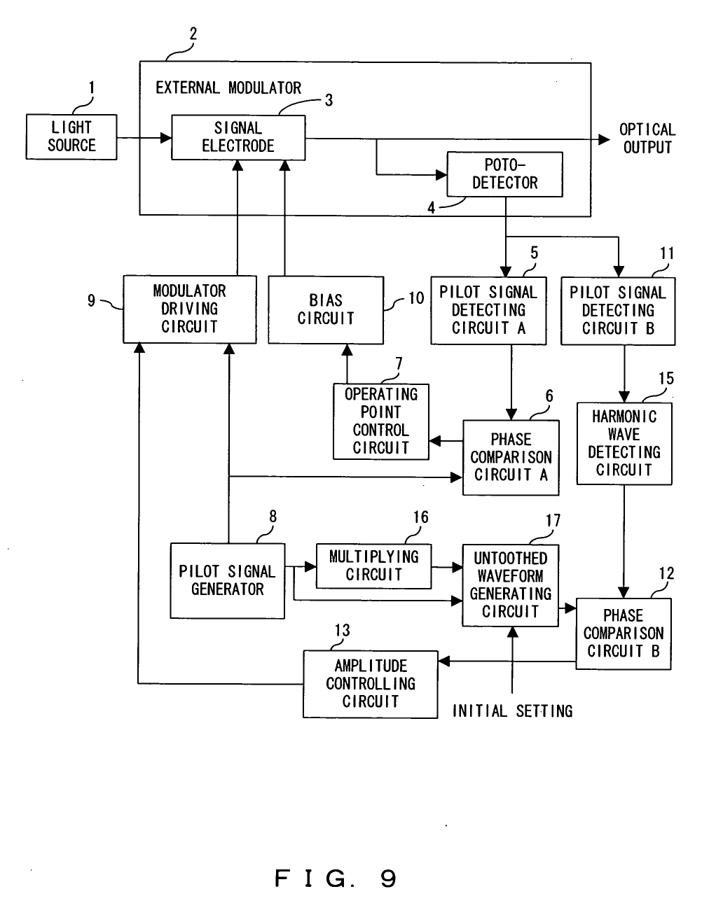

FIGS. 9 through 12 show the second principle of the present invention.

(2) The phase of the pilot signal and the amplitude of a frequency component whose frequency is twice as much as that of a pilot signal are detected and are fed back to a modulation driving circuit which changes the driving amplitude of a PCM signal.

FIG. 9 shows the basic configuration of the optical modulator according to the second principle.

In FIG. 9, both drift compensation and optical output amplitude compensation are conducted only by one pilot signal of the conventional drift compensation circuit. Here, the description of the conventional drift compensation circuit is omitted. The peak waveform of a pilot signal superimposed by a modulator driving circuit 9 is detected from the pilot signal detecting circuit B 11, and a harmonic wave detecting circuit 15 detects a signal amplitude having a frequency twice as much as that of the pilot signal, from the output of the pilot signal detecting circuit B 11.

A multiplexing circuit 16 generates a signal with a frequency twice as much as that of a pilot signal generated by a pilot generator 8. Then, an untoothed waveform generating circuit 17 generates a waveform obtained by untoothing the signal with a frequency having twice as much as that of a pilot signal for each cycle. Then, an untoothed waveform generating circuit 17 combines the pilot signal with the original signal to generate a waveform in which signals with a doubled frequency are untoothed every other cycle (a signal with a doubled frequency is synchronized with the pilot signal at initial setting). Then, a phase comparing circuit B 12 compares the phase of the pilot signal detected by the harmonic wave detection circuit 15 with that of the untoothed signal with a doubled frequency. An amplitude controlling circuit 13 changes the driving amplitude of the modulator so that the output-amplified signal amplitude of the output signal of this phase comparison circuit 12 is maximized and maintains the amplitude and extinction ratio of the optical output signal constant even if the Vπ characteristic changes. The function indicated by reference numerals 1 through 10 automatically adjust bias in the same way as conventional ones.

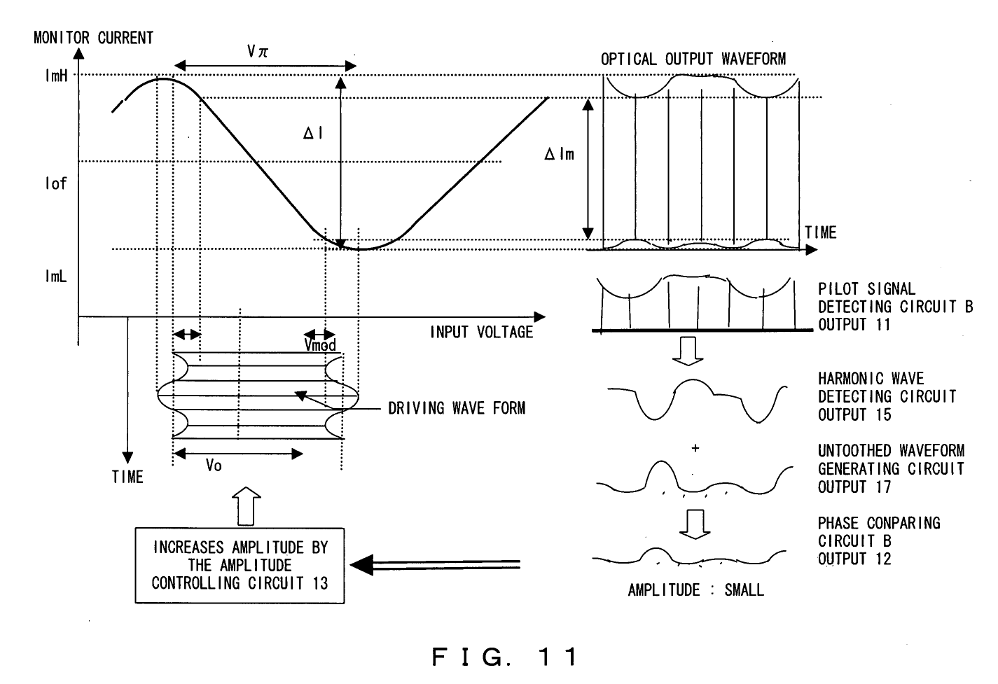

a) In the case that the amplitude of the driving waveform is the same as Vπ (FIG. 11)

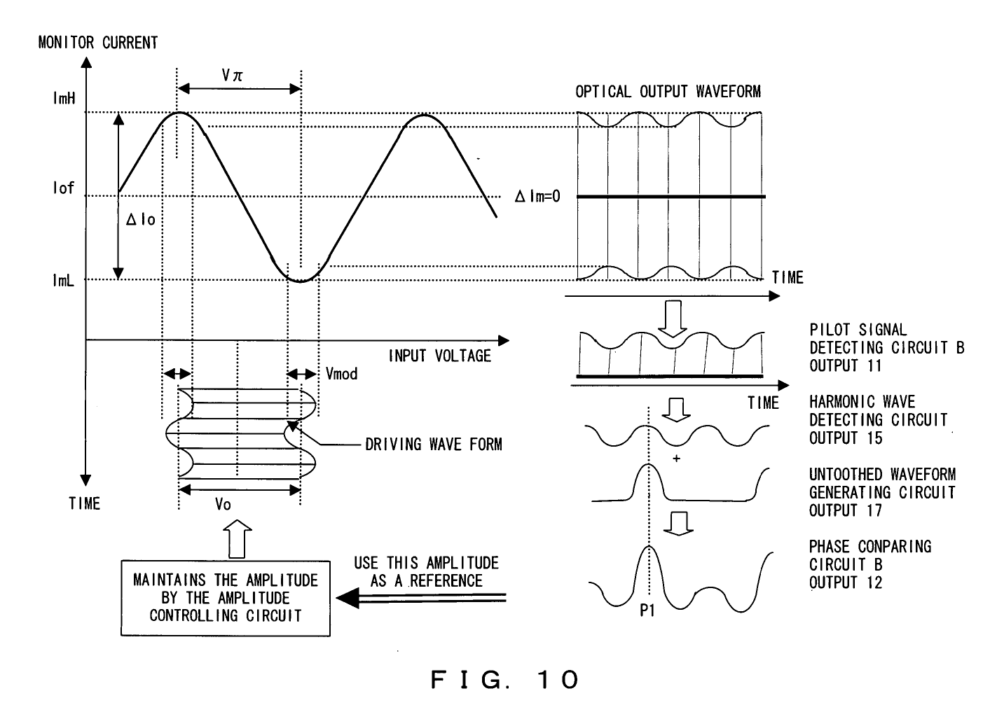

Firstly, if the amplitude of the electric input (driving waveform) of an external modulator is the same as Vπ, a superimposed pilot signal touches or crosses the extremum point of the static characteristic curve of the external modulator. Therefore, the superimposed pilot signal takes the optical output waveform shown in FIG. 10, and a signal with a frequency twice as much as that of the superimposed pilot signal is superimposed on the optical waveform. Then, the peak waveform (upper waveform) of the optical output waveform is detected from the pilot signal detecting circuit B 11, and the harmonic wave detection circuit 15 detects a signal amplitude with a frequency twice as much as that of the pilot signal from the output of the pilot signal detecting circuit B 11.

The untoothed waveform (output 17) of the frequency having a value twice as much as that of the pilot signal is initially set to the phase P1 shown in FIG. 10, and the phase comparison circuit B 12 compares the phase of this waveform with that of the waveform detected by the harmonic wave detection circuit 15. For example, if a simple addition circuit is used as this phase comparison circuit B 12, the amplitude of output-amplified output signal of the phase comparison circuit B 12 becomes as shown in FIG. 10, and the relationship between Vπ and the amplitude of the driving waveform is determined based on this amplitude.

b) In the case that the amplitude of the driving waveform is smaller than Vπ (FIG. 11)

Next, if the amplitude of the driving waveform is smaller than Vπ, the superimposed pilot signal is located inside the extremum point of the static characteristic curve of the external modulator. Therefore, the superimposed pilot signal takes the optical output waveform shown in FIG. 11, and the component of a frequency having twice as much as that of the superimposed pilot signal decreases. The peak waveform (upper waveform) of the optical output waveform is detected from the pilot signal detecting circuit B 11, and the harmonic wave detection circuit 15 detects a signal amplitude with a frequency having twice as much as that of the pilot signal from the output of the pilot signal detecting circuit B 11, for example, by a band pass filter.

Then, the phase comparison circuit B 12 compares the phase of the untoothed waveform of a frequency having twice as much as that of the pilot signal with that of the waveform detected by the harmonic wave detection circuit 15. For example, if a simple addition circuit is used as this phase comparison circuit, the amplitude of the output signal of the phase comparison circuit B 12 becomes as shown in FIG. 11. If the amplitude of the driving waveform is the same as Vπ, the amplitude decreases. In this case, the amplitude of the driving waveform is determined to be smaller than Vπ, and the amplitude controlling circuit 13 controls so as to increase the driving amplitude.

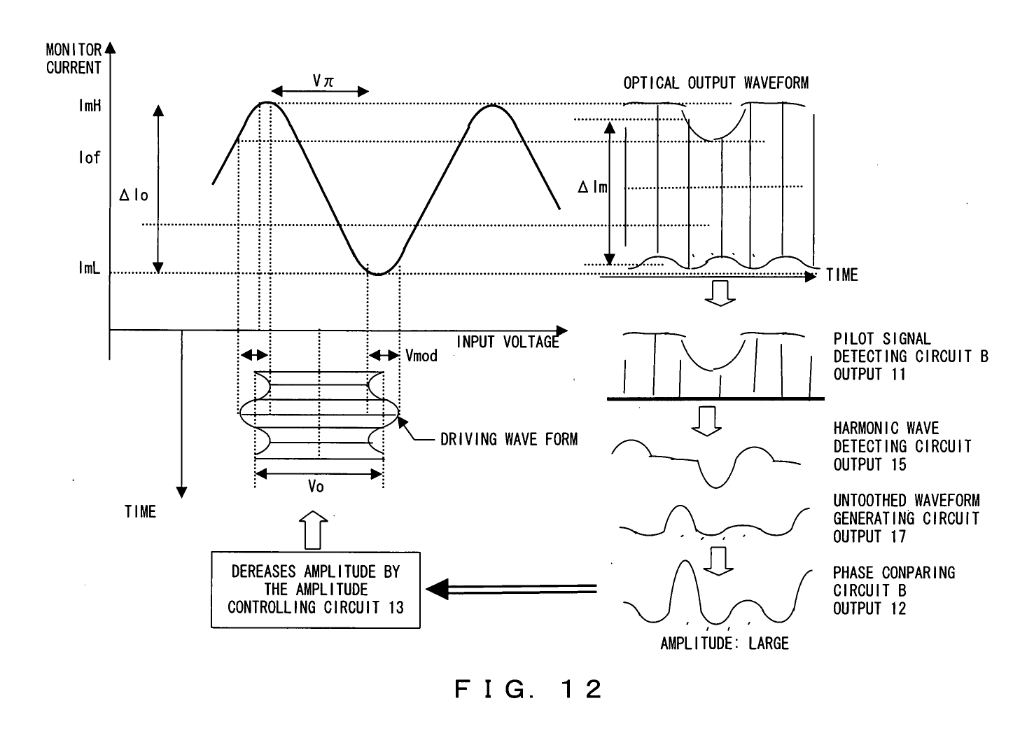

c) In the case that the amplitude of the driving waveform is larger than Vπ (FIG. 12)

Next, if the amplitude of the driving waveform is larger than Vπ, the superimposed pilot signal is located outside the extremum point of the static characteristic curve of the external modulator. Therefore, the superimposed pilot signal takes the optical output waveform shown in FIG. 12, and the component of a frequency having twice as much as that of the superimposed pilot signal decreases. Then, the peak waveform (upper waveform) of the optical output waveform is detected from the pilot signal detecting circuit B11, and the harmonic wave detection circuit 15 detects a signal amplitude with a frequency twice as much as that of the pilot signal, from the output of the pilot signal detecting circuit B 11, for example, using a band pass filter. If the amplitude of the driving waveform is smaller than Vπ, the phase of this waveform becomes almost the reverse of that of the superimposed pilot signal.

Then, the phase comparison circuit B12 compares the phase of the untoothed waveform of a frequency having twice as much as that of the pilot signal with that of the waveform detected by the harmonic wave detection circuit 15. For example, if a simple addition circuit is used as this phase comparison circuit, the amplitude of the output signal of the phase comparison circuit B1 2 becomes as shown in FIG. 12. In this case, the amplitude of the driving waveform becomes larger than one obtained when the amplitude of the driving waveform is the same as Vπ. In this case, the amplitude of the driving waveform is determined to be larger than Vπ, and the amplitude controlling circuit 13 controls so as to decrease the driving amplitude.

By superimposing a pilot signal on the optical modulator upon this principle, extracting information about how to convert the output into an optical pilot signal and feeding it back, an optical transmitter that stably operates without the degradation of an optical output power and an extinction ratio even if the bias characteristic of the optical modulator changes.

The above-mentioned basic configuration described is described in detail below.

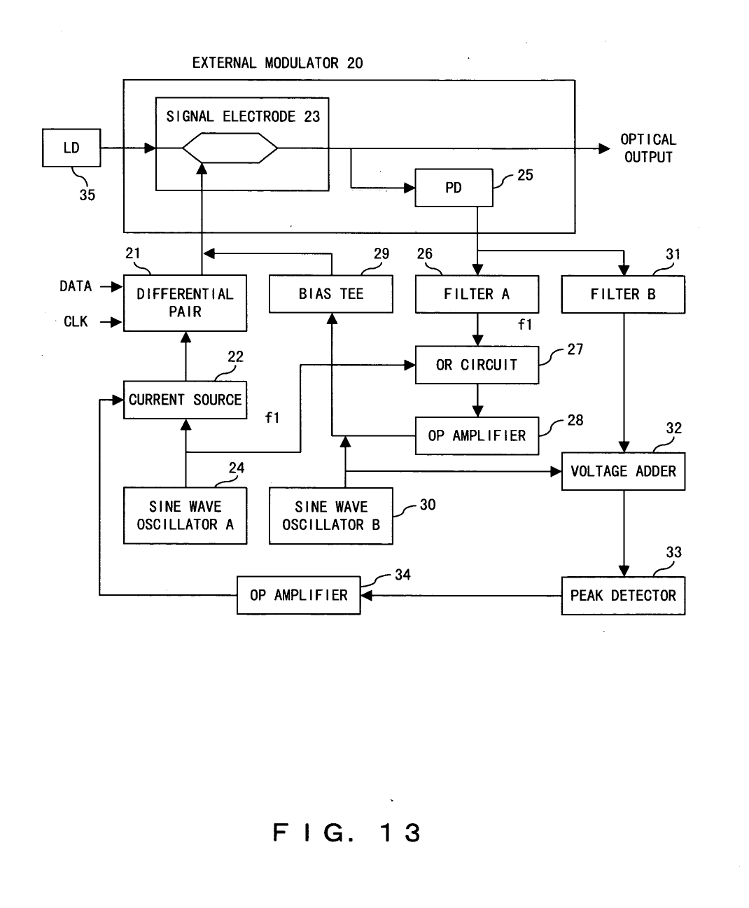

FIG. 13 shows the first configuration of the optical modulator according to the first principle.

The DATA and CLK of a PCM signal inputted to a differential pair 21, using a Mach-Zhender external modulator using lithium niobate. In this case, a modulator driving circuit 9 is composed of the differential pair 21 and a current source 22, and modulation is applied in the signal electrode 23 of an external modulator 20. CW light from an LD (laser diode) 35 is modulated by the external modulator and an optical output is generated. The current source 22 superimposes a pilot signal with a frequency f1 generated by a sine wave oscillator A 24, on the optical output. Then, a PD (photo diode) 25 receives the optical output, and a filter A 26 detects the frequency of the optical signal corresponding to a pilot signal with a frequency f1. Then, the frequency is supplied to a bias tee 29 through an OR circuit 27 and an OP (operational) amplifier 28. The bias tee 29 controls the bias of a voltage applied to the signal electrode 23 of the external modulator 20 and compensates for the drift of the Vπ characteristic. This operation is a prior art.

The sine wave oscillator B 30 applies a pilot signal B with a frequency f2 to the signal electrode of the external modulator 20 through the bias tee 29, and the optical signal is modulated. A PD receives this optical signal. Then, a filter B 31 detects the frequency element of an optical signal corresponding to the pilot signal B with frequency f2. Then, a voltage adder 32 adds the signal of the sine wave oscillator B 30 to the frequency component. Then, a peak detector 33 detects the peak of this amplitude, controls the current of the current source 22, based on its hight, and changes the driving amplitude of the modulator, outputted from the differential pair 21. As a result, if Vπ changes, the degradation of the output power and extinction ratio are compensated. An OP amplifier amplifies the output of the peak detector 33 so that the output is suitable for a signal to be supplied to the current source 22.

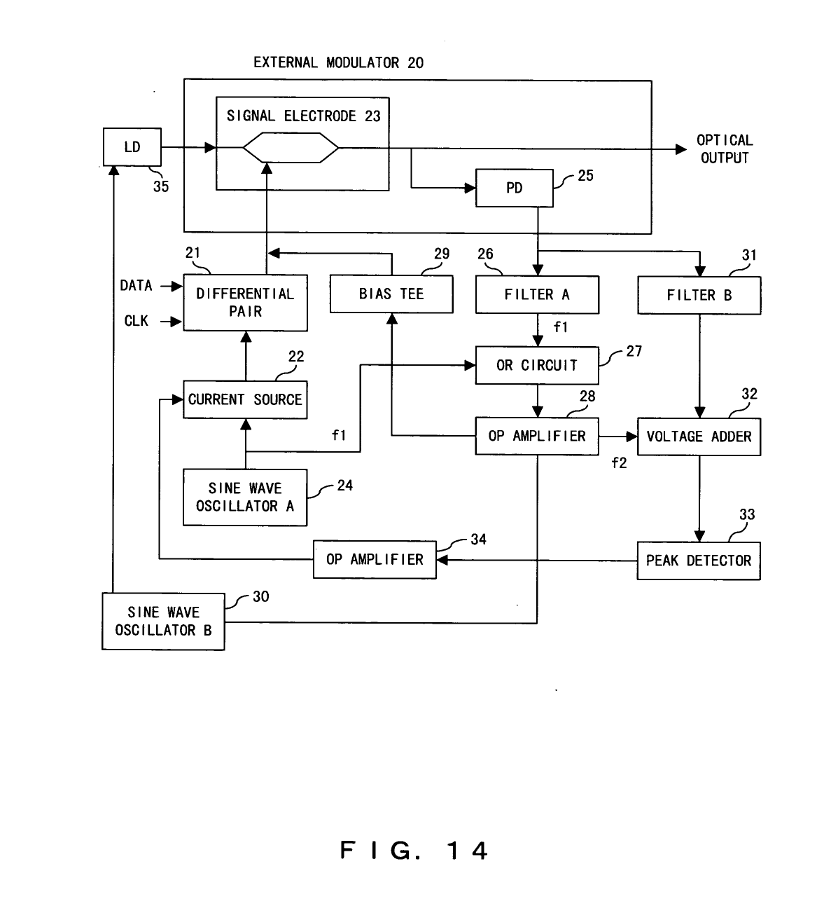

FIG. 14 shows the second configuration of the optical modulator according to the first principle.

In FIG. 14, the same reference numerals are attached to the same components shown in FIG. 13, and only different components are described.

The sine wave oscillator B 30 inputs a pilot signal B with frequency f2 to an LD 35 lighting a CW light source and the optical signal is modulated. The PD 25 receives this optical signal. Therefore, the pilot signal B generated by the sine wave oscillator B 30 is not superimposed on the optical signal using the external modulator 20, but the external modulator 20 modulates light which is modulated with the pilot signal B by directly changing the driving voltage of LD 35, using a signal, such as data, etc. The remaining operation is the same as that shown in FIG. 13.

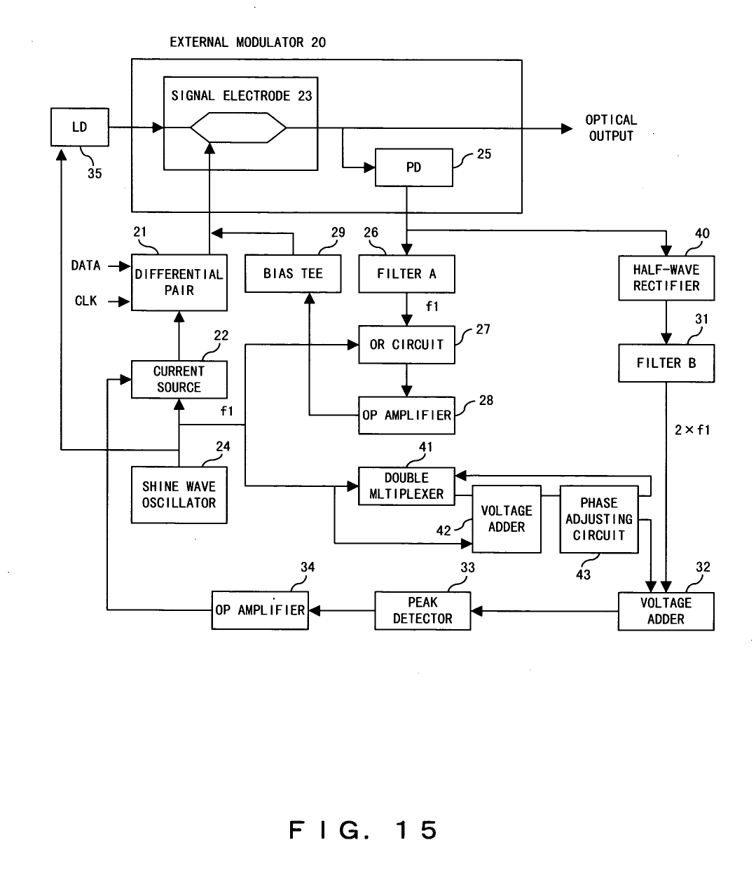

FIG. 15 shows the configuration of the optical modulator according to the second principle.

In FIG. 15, the same reference numerals are attached to the same components shown in FIG. 13.

Aloop composed of a differential pair 21, a signal electrode 23, a PD 25, filter A 26, OR circuit 27, operational amplifier 28, bias tee 29, a sine wave oscillator 44 and a current source 22 is an operating point controlling circuit using a pilot signal with frequency f1, and is the same as the prior art and that shown in FIG. 13. Therefore, its description is omitted.

In this configuration, the output signal of the PD 25 is half-wave rectified by a half-wave rectifier 40, and the upper waveform of a modulated signal, being the received signal of the PD 25, is detected. The oscillation frequency of the sine wave oscillator detects the second harmonic wave component in a filter B 31 having a filter band at twice as much as f1. Then, a voltage adder 42 adds the waveform of a frequency obtained by double-multiplexing the output of the sine wave oscillator 44 by a double-multiplexer 41 to that of a pilot signal with frequency fl (specifically, an untoothed waveform is generated by taking the AND of them). Then, a phase adjustment circuit 43 adjusts the phase of the pilot signal and that of the double-multiplexed signal. Then, a voltage adder 32 adds the signal after the phase adjustment to the output of the filter B 31, and a peak detector 33 detects the added signal. Then, the current of the current source 22 is controlled through an OP amplifier 34 by setting a specific value of the peak-detected signal amplitude as a threshold value and comparing the added signal with the threshold value to change the driving amplitude of the modulator, outputted from the differential pair 21. As a result, if Vπ changes, the degradation of the output power and extinction ratio are compensated. In this case, the peak-detected result of the output of the voltage adder 32, obtained when Vπ is the same as the driving waveform, which is mentioned in the description of the second principle, is used as the threshold value.

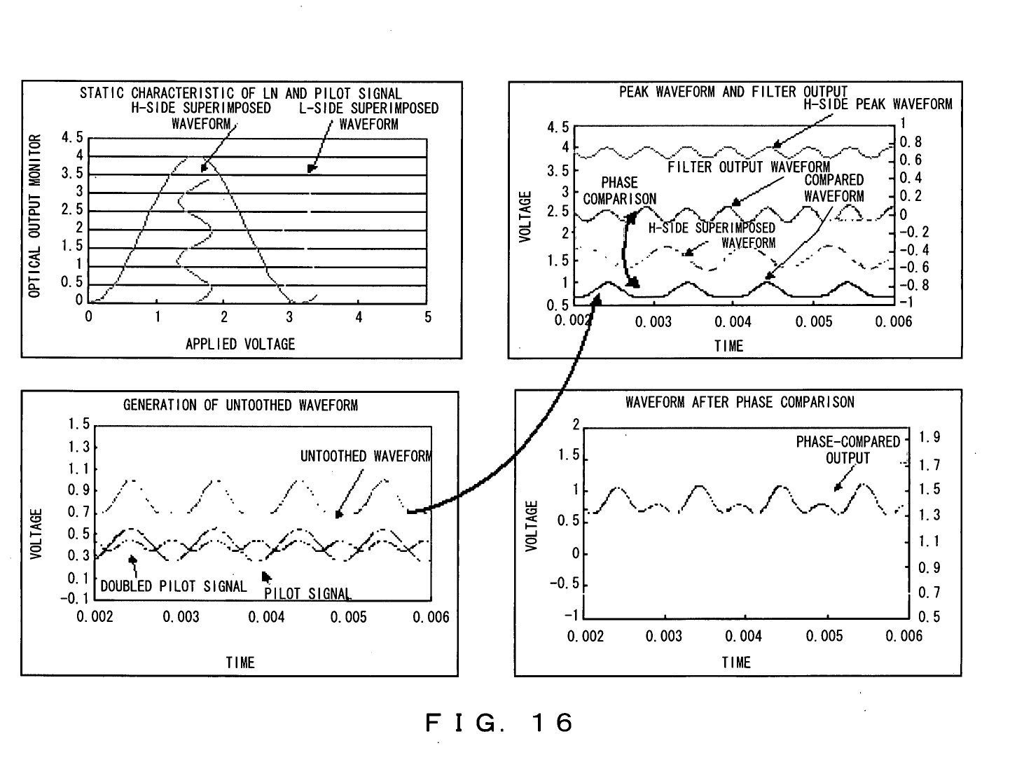

FIGS. 16 through 18 show each signal waveform in the operation according to the second principle.

FIG. 16 shows signal waveforms obtained when the driving waveform is the same as Vπ.

The upper left drawing shows the relationship between the static characteristic of an LN modulator and a pilot signal. This corresponds to FIG. 10. The lower left drawing shows a pilot signal and a pilot signal with a frequency twice as much as the pilot signal, and also an untoothed waveform obtained by adding them. The upper right drawing shows a waveform obtained by extracting an upper waveform from the optical output of the LN modulator and a filter output waveform obtained by extracting a frequency twice as much as that of the pilot signal, from the waveform. The waveform at the bottom of the upper right drawing shows an untoothed waveform to be compared with the filter output waveform. The dotted waveform of the upper right drawing shows a superimposed driving waveform that generates a portion corresponding to the upper waveform of the optical signal in the superimposed driving waveform applied to the LN modulator. The lower right drawing shows a waveform (upper) obtained by comparing the phase of the untoothed waveform with that of the pilot signal with a frequency twice as much as that of the pilot signal, and a waveform (lower) obtained by adding the voltage of the phase-compared waveform with that of the filter output waveform.

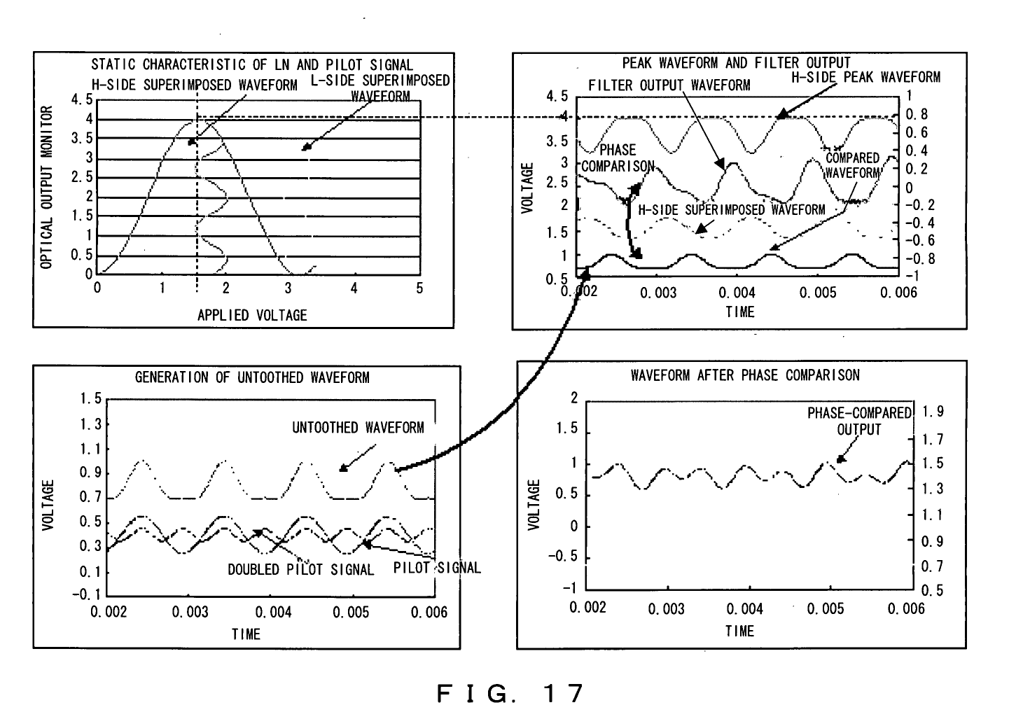

FIG. 17 shows signal waveforms obtained when the amplitude of the driving waveform is smaller than Vπ.

The upper left drawing shows the relationship between the static characteristic of an LN modulator and a pilot signal. This corresponds to FIG. 11. Like FIG. 16, the lower left drawing shows a pilot signal, a signal with a frequency twice as much as that of the pilot signal and an untoothed waveform. The upper right shows an upper peak waveform corresponding to modulation by the pilot signal of the optical signal, a filter output waveform obtained by extracting a frequency twice as much as that of the pilot signal from the waveform, the upper superimposed signal waveform of the driving signal and the untoothed waveform. What is different from FIG. 16 is that the upper peak waveform reaches the ceiling since the amplitude of the driving waveform is smaller than Vπ, and that the frequency is the same as that of the pilot signal. The filter output also takes a distorted waveform. The lower right shows a waveform obtained by comparing the phase of the untoothed waveform with that of the pilot signal with a frequency twice as much as that of the pilot signal, and a waveform obtained by adding the voltage of the untoothed waveform with that of the filter output waveform.

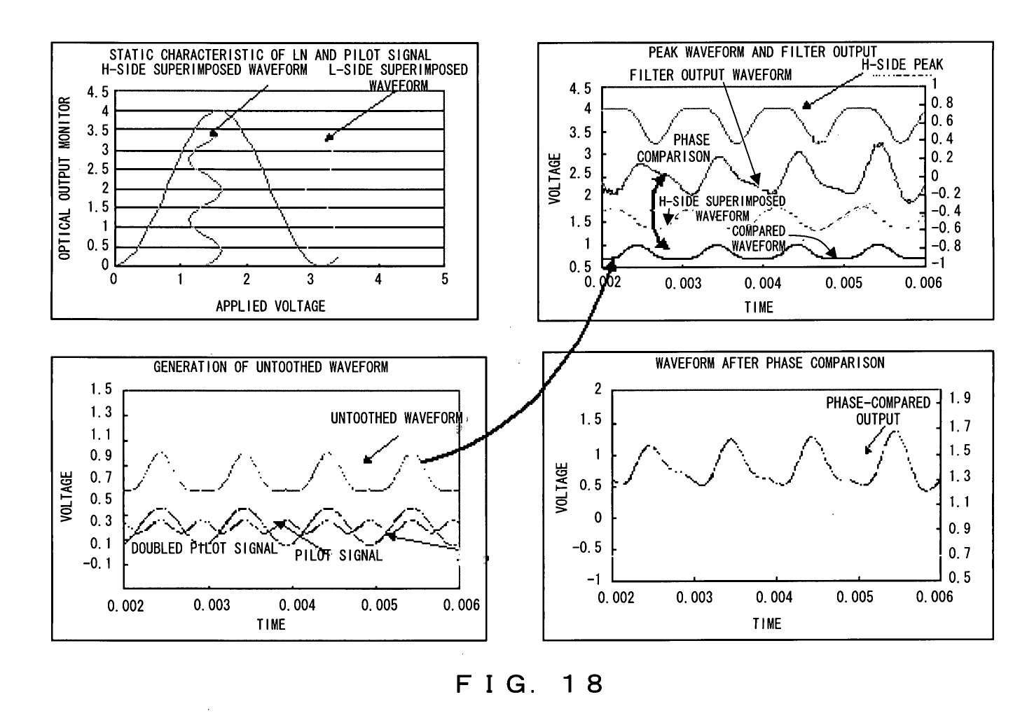

FIG. 18 shows signal waveforms obtained when the amplitude of the driving waveform is larger than Vπ.

The upper left drawing shows the relationship between the static characteristic of an LN modulator and a pilot signal. This corresponds to FIG. 12. Like FIG. 16, the lower left drawing shows a pilot signal, a signal with a frequency twice as much as that of the pilot signal and an untoothed waveform. The upper right drawing shows the same signal waveforms as those shown in FIGS. 16 and 17. However, since the amplitude of the driving waveform is larger than Vπ, the upper peak waveform reaches the ceiling and the filter output takes a distorted waveform. Besides, the phase of the upper peak waveform becomes the reverse of that obtained when the amplitude of the driving waveform is smaller than Vπ. The lower right shows a waveform obtained by comparing the phase of the untoothed waveform with that of the pilot signal with a frequency twice as much as that of the pilot signal, and a waveform obtained by adding the voltage of the untoothed waveform with that of the filter output waveform.

According to the present invention, the amplitude of the driving signal of the modulator can be appropriately controlled following the change of the static characteristic of the modulator accompanying the switch of a wavelength and the change of a bit rate. Therefore, the degradation of the output power and extinction ratio of the optical output of the modulator can be prevented.

What is claimed is:

1. An optical modulator having a function to compensate for the change of the static characteristic of an external modulator, comprising:
a superimposition unit superimposing a signal with a low frequency on an optical signal outputted by the external modulator;
an extraction unit extracting a component of an optical signal corresponding to the superimposed signal;
a comparison unit comparing the extracted signal with the signal with the low frequency; and
a change unit changing an amplitude of a driving signal to be supplied to the external modulator, based on an output of the comparison unit.

2. The optical modulator according to claim 1, wherein
said comparison unit outputs a result of adding a voltage of the extracted signal to a voltage of the signal with the low frequency.

3. The optical modulator according to claim 1, wherein
said comparison unit detects cases where an amplitude of the driving signal is larger and smaller than the static characteristic of the external modulator, using as reference a comparison value in a case that the static characteristic of the external modulator and an amplitude of the driving signal coincide.

4. The optical modulator according to claim 1, wherein
said comparison unit compares an untoothed waveform obtained by removing alternate pulses from a signal with a frequency twice as much as that of the signal with the low frequency, with a waveform with a frequency component twice as much as that of the signal with the low frequency.

5. The optical modulator according to claim 1, wherein
said superimposition unit superimposes a signal with the low frequency on an optical output of the external modulator by applying a signal voltage with the low frequency to a driving electrode of the external modulator.

6. The optical modulator according to claim 1, wherein
said superimposition unit superimposes a signal with the low frequency on an optical output of the external modulator by directly controlling a light source supplying the external modulator with light.

7. An optical modulator having a function to compensate for the change of the static characteristic of an external modulator, comprising:
a superimposition unit superimposing signals each with a first or second low frequency on an optical signal outputted by the external modulator;
an extraction unit extracting a component of an optical signal corresponding to the superimposed signal;
a comparison unit comparing the extracted signal and signals with the first and the second low frequency;
an amplitude changing unit changing an amplitude of a driving signal to be supplied to the external modulator, based on an output of the comparison unit; and
a voltage changing unit changing an operating point voltage to be supplied to the external modulator, based on the output of the comparison unit.

8. A method for compensating for the change of the static characteristic in an external modulator, comprising:
superimposing a signal with a low frequency on an optical signal outputted by the external modulator;
extracting a component of an optical signal corresponding to the superimposed signal;
comparing the extracted signal with the signal with the low frequency; and
changing an amplitude of a driving signal to be supplied to the external modulator, based on an output of the comparison unit.

9. The method according to claim 8, wherein
in said comparison step, a result of adding a voltage of the extracted signal is added to a voltage of the signal with the low frequency.

10. The method according to claim 8, wherein
in said comparison step, cases where an amplitude of the driving signal is larger and smaller than the static characteristic of the external modulator, are detected using as reference a comparison value in a case that the static characteristic of the external modulator and an amplitude of the driving signal coincide.

11. The method according to claim 8, wherein
in said comparison step, an untoothed waveform obtained by removing alternate pulses from a signal with a frequency twice as much as that of the signal with the low frequency is compared with a waveform with a frequency component twice as much as that of the signal with a low frequency.

12. The method according to claim 8, wherein
in said superimposition step, a signal with the low frequency is superimposed on an optical output of the external modulator by applying a signal voltage with the low frequency to a driving electrode of the external modulator.

13. The method according to claim 8, wherein
in said superimposition step, a signal with the low frequency is superimposed on an optical output of the external modulator by directly controlling a light source supplying the external modulator with light.

14. A method for compensating for the change of the static characteristic of an external modulator, comprising:
superimposing signals each with a first or second low frequency on an optical signal outputted by the external modulator;
extracting a component of an optical signal corresponding to the superimposed signal;
comparing the extracted signal and signals with the first and the second frequency;
changing an amplitude of a driving signal to be supplied to the external modulator, based on an output of the comparison step; and
changing an operating point voltage to be supplied to the external modulator, based on the output of the comparison step.
